(19) United States
(12) Patent Application Publication
(10) Pub. No.: US 2005/0098344 A1
(43) Pub. Date: May 12, 2005

(54) Shielded electrical wire construction and method of manufacture

(75) Inventor: Floyd Ysbrand, Joplin, MO (US)

Correspondence Address: NIXON & VANDERHYE, PC, 1100 N GLEBE ROAD, 8TH FLOOR, ARLINGTON, VA, 22201-4714, US

(73) Assignee: Midcon Cables Company, Joplin, MO (US)

(21) Appl. No.: 11/008,612

(22) Filed: Dec. 10, 2004

Related U.S. Application Data
(63) Continuation of application No. 10/407,176, filed on Apr. 7, 2003, now abandoned.

(51) Int. Cl. H01B 7/29

(52) U.S. Cl. 174/102 SC

(57) ABSTRACT

A shielded electrical wire construction, comprising an insulated wire, a conductive coating surrounding the insulated wire to provide a positive attenuation of and protection from electromagnetic and radio frequency interference. The conductive coating comprises a metallic powder dispersed in a PTFE solution. An outer insulation coating formed of PTFE surrounds the conductive coating.

### FIELD OF THE INVENTION

The present invention relates to shielded electrical wire and, more particularly, to such wire having a conductive coating on the outer surface thereof which provides a positive attenuation of and protection from electromagnetic and radio frequency interference.

### BACKGROUND OF THE INVENTION

Up to the present time, electric wire has been provided with metal braiding, tapes, foils or the like in order to provide a positive attenuation of and protection from electromagnetic and radio frequency interference. Such shielded wire has been complicated in construction, expensive to manufacture, relatively rigid, high in weight and large in diameter.

The new and improved shielded electrical wire construction of the present invention is not subject to any of the disadvantages of previously used shielded wire and possesses certain advantages not found in previously used wire.

Accordingly, it is a primary object of the present invention to provide a new and improved shielded electrical wire construction and method of manufacturing same wherein the shielded wire is simple in construction, inexpensive to manufacture, light in weight, small in diameter and of improved flexibility compared to previously used shielded wire.

### SUMMARY OF THE INVENTION

In accordance with the present invention, insulated electrical wire of any suitable type is provided with a conductive coating on the outer surface thereof in a sufficient amount to provide a positive attenuation of and protection from electromagnetic and radio frequency interference. The conductive coating comprises a metallic powder of copper, iron, nickel, aluminum, silver, gold or carbon, alone or in any desired mixture. The powder is blended into a dispersion coating of polytetrofluoroethylene (PTFE), generally known under the trademark TEFLON, or blended into a PTFE striping ink, in a ratio that, when cured at sufficient temperature, provides a conductive surface that bonds to the wire.

An outer insulation is applied over the conductive coating to protect it from abrasion and chemical environments. The insulation may be in the form of a coating of PTFE which may be in the form of a tape that is spirally wrapped around the coated wire and then drawn through a heated metal compression sealer to provide the insulation coating around the conductive coating. The outer insulation can also be in the form of a PTFE dispersion solution or ink without any metal content.

The new and improved shielded electrical wire construction of the present invention is simple in construction, inexpensive to manufacture, light in weight, small in thickness and of improved flexibility compared to previously used shielded wire utilizing metal tapes, braids, foils or the like. Weight saving is particularly important in view of the stringent requirements for present day, lightweight space in various environments, such as aeronautical environments.

### BRIEF DESCRIPTION OF THE DRAWINGS

FIG. 1 is a is a perspective view of a portion of a shielded electrical wire, with parts broken away, constructed in accordance with the principles of the present invention; and

FIG. 2 is a schematic view of apparatus for manufacturing the new and improved shielded electrical wire shown in FIG. 1.

### DESCRIPTION OF THE PREFERRED EMBODIMENTS

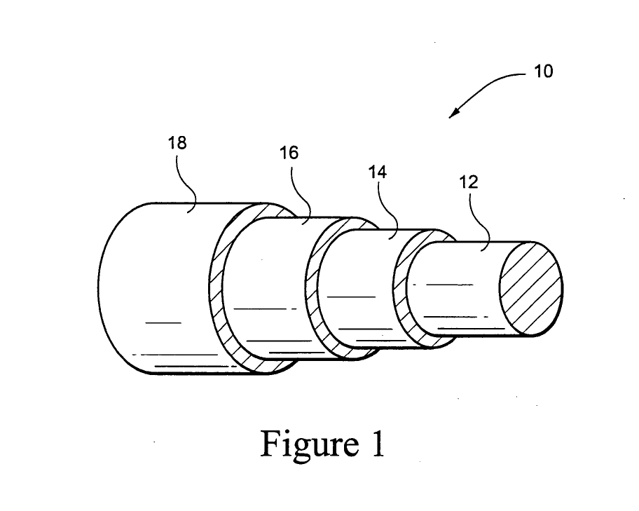

Referring to FIG. 1, the shielded electrical wire 10 of the present invention generally comprises an electrical wire 12 of any suitable construction or material, an insulation coating 14 of any suitable construction or material surrounding the wire 12, a conductive coating 16 surrounding the insulation coating 14 and constructed in accordance with the principles of the present invention, and an outer insulation coating 18 surrounding the conductive coating 16 and constructed in accordance with the principles of the present invention. The wire 12 and insulation layer 14 may be any type of conventional or suitable PTFE insulated electrical wire. The diameter of the insulated wire 12, 14 may be of any suitable size, e.g., approximately 0.01 to 1.1 inches.

In accordance with the present invention, the conductive coating 16 is applied to the outer surface of the insulated wire 12, 14 to provide a positive attenuation of and protection from electromagnetic and radio frequency interference. The conductive coating 16 comprises a metallic powder formed of copper, iron, nickel, aluminum, silver, gold or carbon, alone or in suitable mixture, which is blended into a PTFE dispersion or ink coating in a ratio that, when cured at sufficient temperature, provides a suitable conductive surface that bonds to the insulated wire 12, 14. As an illustrative embodiment, the metallic powder may be blended in any suitable ratio (e.g., equal parts) with the PTFE dispersion solution or ink. Also, the metallic powder may be in a particle size of approximately 0.1 to 10 microns.

The outer insulation coating 18 surrounds the conductive coating 16 and may be formed by spirally wrapping a PTFE film tape around the coated and insulated wire, and then heating and compressing it to provide the outer insulation coating 18. Alternatively, the outer insulation coating 18 may be formed by drawing the wire with the conductive coating 16 thereon through a PTFE dispersion solution or ink reservoir with no metallic content.

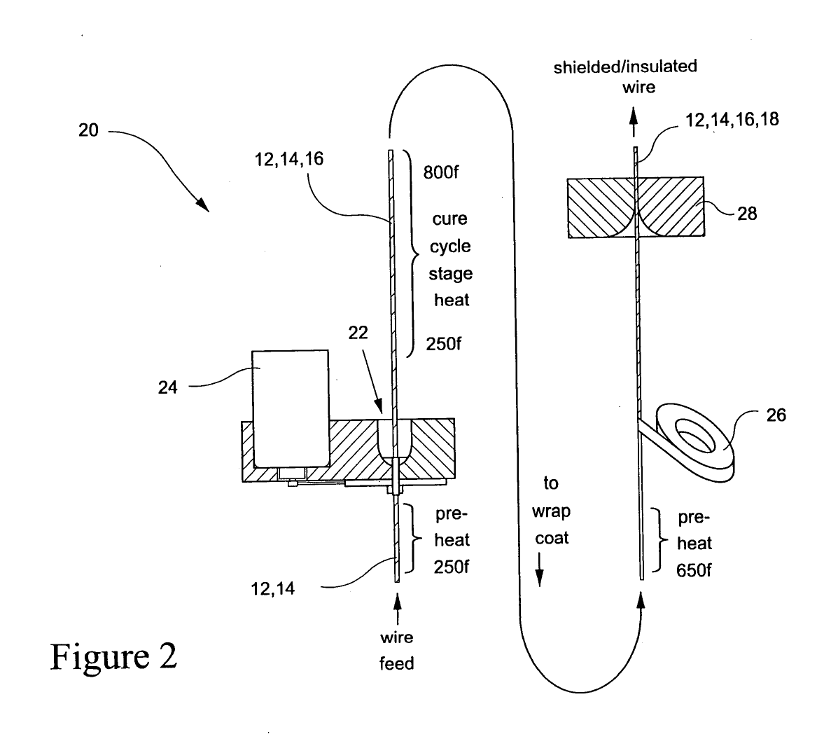

FIG. 2 illustrates one embodiment of apparatus 20 for manufacturing the shielded electrical wire 10 shown in FIG. 1 in accordance with the method of present invention. The blended metallic powder-PTFE dispersion solution or ink is provided in a reservoir 22 that may be agitated or rotated by a drive motor 24 or any other suitable device. Preferably, the metallic powder is mixed in various suitable ratios with the PTFE dispersion solution or ink and the mixture is set for at least one hour to allow any air to escape. The mixture is then gently re-mixed prior to placement in the reservoir 22.

Before the insulated wire 12, 14 is coated, it is cleaned in any suitable manner, such as by wiping with a paper towel saturated with methyl ethyl keytone (MEK) and allowed to dry. The insulated wire 12, 14 is then preheated to approximately 250° F. and passed through the metallic powder-PTFE dispersion solution in the reservoir 22 so as to be coated thereby. The insulated wire 12, 14 is passed through the reservoir at a rate of approximately one-half inch per second.

After the coated wire 12, 14, 16 exits the reservoir 22, it is heated to approximately 800° F. to cure the conductive coating 16 thereon. This can be accomplished in any suitable manner, such as by passing the coated wire through a hot air field. The conductive coating 16 may have a thickness of approximately 0.0005 to 0.005 microns.

The cured, coated wire 12, 14, 16 is then preheated to approximately 650° F. and, in one embodiment, a PTFE film wrap 26 is spirally wound thereon to form the outer insulation coating 18. The spirally wrapped wire is then passed through a metal compression sealer 28 of any suitable construction wherein it is heated to approximately 800° F. to form and cure the outer insulation coating 18 on the conductive coating 16. It is also possible to form the outer insulation coating 18 by passing or drawing the cured, coated wire 12, 14, 16 through a heated PTFE dispersion solution or ink in a reservoir with no metallic content. The outer insulation coating may have a thickness of approximately 0.003 to 0.006 microns.

It will be readily seen from the foregoing description that the new and improved shielded electrical wire 10 of the present invention is simple in construction, easy and inexpensive to manufacture, light in weight, small in diameter and of improved flexibility compared to the previously used metal shielded wire utilizing tapes, braids, foils or the like.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1-16. (canceled)

17. A shielded electrical wire construction, comprising:
a wire insulated by a PTFE coating;
a conductive coating surrounding and in engagement with said insulated wire to provide a positive attenuation of and protection from electromagnetic and radio frequency interference, said conductive coating being formed of uncoated metallic powder dispersed in PTFE; and
an outer insulation coating formed of PTFE surrounding and in engagement with said conductive coating.

18. The shielded electrical wire construction of claim 17 wherein said conductive coating comprises substantially equal parts of metallic powder and PTFE.

19. The shielded electrical wire construction of claim 17 wherein said conductive coating is formed by dispersing said metallic powder in a PTFE solution, passing said wire through said solution and heating and curing said metallic powder-PTFE mixture on said wire to form said conductive coating.

20. The shielded electrical wire construction of claim 17 wherein said metallic powder is selected from the group consisting of copper, iron, nickel, aluminum, silver, gold and carbon, alone or in combination.

21. The shielded electrical wire construction of claim 17 wherein said outer insulation coating is formed of a PTFE film that is spirally wound around said electrical wire having said conductive coating thereon.
